(19) United States
(12) Patent Application Publication
(10) Pub. No.: US 2006/0260051 A1
(43) Pub. Date: Nov. 23, 2006

(54) Patient support apparatus

(76) Inventor: Ohad Paz, Tel Aviv (IL)

Correspondence Address: DEKEL PATENT LTD., DAVID KLEIN, BEIT HAROF'IM, 18 MENUHA VENAHALA STREET, ROOM 27, REHOVOT, 76209, IL

(21) Appl. No.: 11/130,130

(22) Filed: May 17, 2005

(51) Int. Cl. A61G 7/018

(52) U.S. Cl. 5/618; 5/610

(57) ABSTRACT

Patient support apparatus including a middle body support pivotally attached to an upper body support and a leg support by articulated joints therebetween, the leg support including a calf support member and a foot-sole support member, and a linkage device that connects the middle body support, the upper body support and the leg support to a frame, the linkage device being adapted to raise, lower and adjust spatial orientations of the middle body support, the upper body support and the leg support with respect to one another, such that the patient support apparatus is adjustable between reclining, sitting and standing positions, wherein in the standing position the upper body support, the middle body support and the leg support are all generally vertical.

### FIELD OF THE INVENTION

The present invention relates generally to patient support apparatus and particularly to an articulating bed that can be adjusted between reclining, sitting and standing positions.

### BACKGROUND OF THE INVENTION

Many articulated beds are known that have adjustable parts that can be raised and pivoted for supporting invalids, patients and other persons. For example, German Patent Document DE4135224 describes a recliner or bed, which includes a mobile base frame and a movable mattress frame connected by a system of pivoted and articulated links. Two separately controlled reversible electric drives raise or lower the extremities of the frame at its head or foot independently of the height of its center above the base frame. Manual control of the required position of the frame is effected by a controller which incorporates switches for vertical raising and lowering. The bed purports to provide a wide range of heights above ground with controlled parallel motion of the mattress frame. Either end of the bed may be raised or lowered independently, and any subsequent vertical adjustment maintains inclination.

U.S. Pat. Nos. 6,336,235, 6,163,903, 5,715,548, and 5,479,666 (all to Ruehl) describe patient support apparatus having a base and a patient support platform having a head portion and a seat portion. The patient support apparatus further includes a plurality of links configured to coordinate movement of the head portion of the patient support platform relative to the seat portion of the patient support platform.

In one embodiment, a strut is coupled to the base, and the head portion is pivotably coupled to the strut. Pairs of bars are pivotably coupled to the support and seat portion. The bars and strut are configured to automatically coordinate pivoting movement of the head portion relative to the seat portion as the seat portion moves downward toward the base.

In another embodiment, the bed is configured like a table and is convertible to a chair position that permits patient egress from a foot end thereof. Linkages are connected between the base and the platform for either raising the entire seat section or lowering the entire seat section relative to the base, and for pivoting the head and foot sections to convert the platform to and between the generally planar table position and the chair position.

### SUMMARY OF THE INVENTION

The present invention seeks to provide a novel patient support apparatus, as described in detail hereinbelow. Unlike the prior art, in the present invention, the patient support apparatus has a foot-sole member that can be raised and lowered to different positions.

There is thus provided in accordance with an embodiment of the invention patient support apparatus including a middle body support pivotally attached to an upper body support and a leg support by articulated joints therebetween, the leg support including a calf support member and a foot-sole support member, and a linkage device that connects the middle body support, the upper body support and the leg support to a frame, the linkage device being adapted to raise, lower and adjust spatial orientations of the middle body support, the upper body support and the leg support with respect to one another, such that the patient support apparatus is adjustable between reclining, sitting and standing positions, wherein in the standing position the upper body support, the middle body support and the leg support are all generally vertical. The foot-sole support member may be coupled to an actuator adapted to move the foot-sole support member closer to and further from the articulated joint between the leg support and the middle body support.

The system may include further features. For example, in accordance with non-limiting embodiments of the invention, the middle body support, the upper body support and/or the calf support member may be slidingly mounted in the frame for sliding motion along a longitudinal axis that extends through a lower end of the calf support member and an upper end of the upper body support. Arm rests may be provided, wherein a position of the arm rests with respect to at least one of the middle body support and the upper body support is adjustable.

A first adjustable link may be attached to the middle body support and the frame, adapted to modify an angular orientation of the middle body support relative to the frame. A second adjustable link may be attached to the middle body support and the upper body support, adapted to modify an angular orientation of the middle body support relative to the upper body support.

### BRIEF DESCRIPTION OF THE DRAWINGS

The present invention will be understood and appreciated more fully from the following detailed description taken in conjunction with the drawings in which:

FIGS. 1 and 2 are simplified side-view illustrations of patient support apparatus, constructed and operative in accordance with an embodiment of the present invention, in respective reclining and almost-standing positions;

FIGS. 3 and 4 are simplified pictorial illustrations of the patient support apparatus of FIGS. 1 and 2, in respective reclining and almost-standing positions;

FIGS. 5 and 6 are simplified pictorial illustrations of the patient support apparatus of FIGS. 1 and 2, in a full standing position, respectively showing external and internal components of the apparatus; and

FIG. 7 is a simplified pictorial illustration of the patient support apparatus of FIGS. 1 and 2, in a reclining position, showing internal components of the apparatus.

### DETAILED DESCRIPTION OF EMBODIMENTS

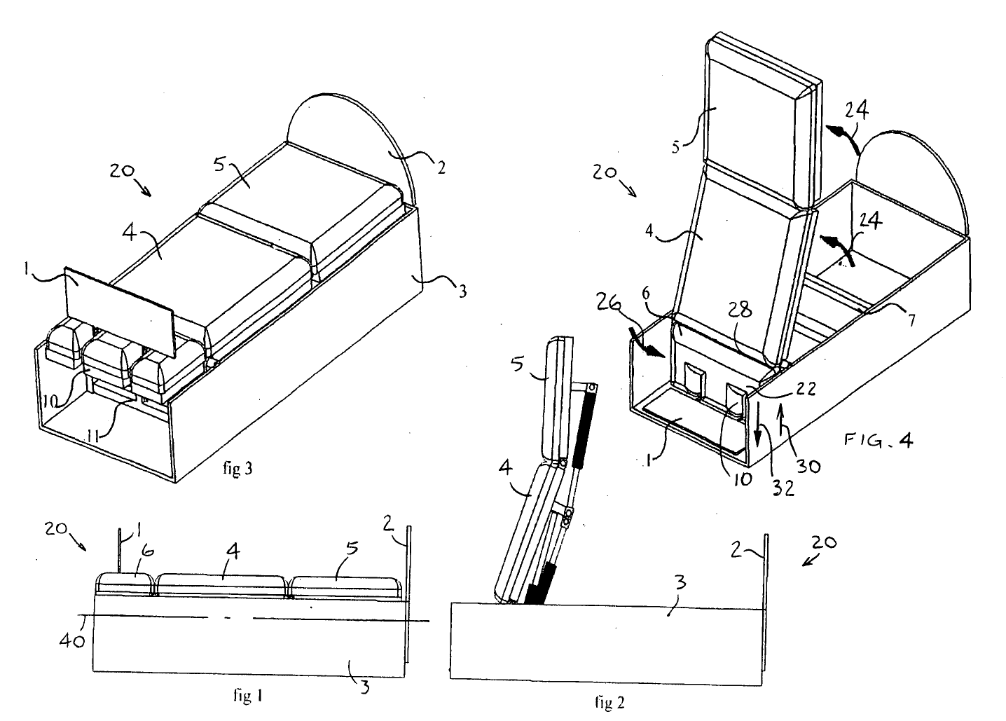

Reference is now made to FIGS. 1-7, which illustrate patient support apparatus 20, constructed and operative in accordance with an embodiment of the present invention.

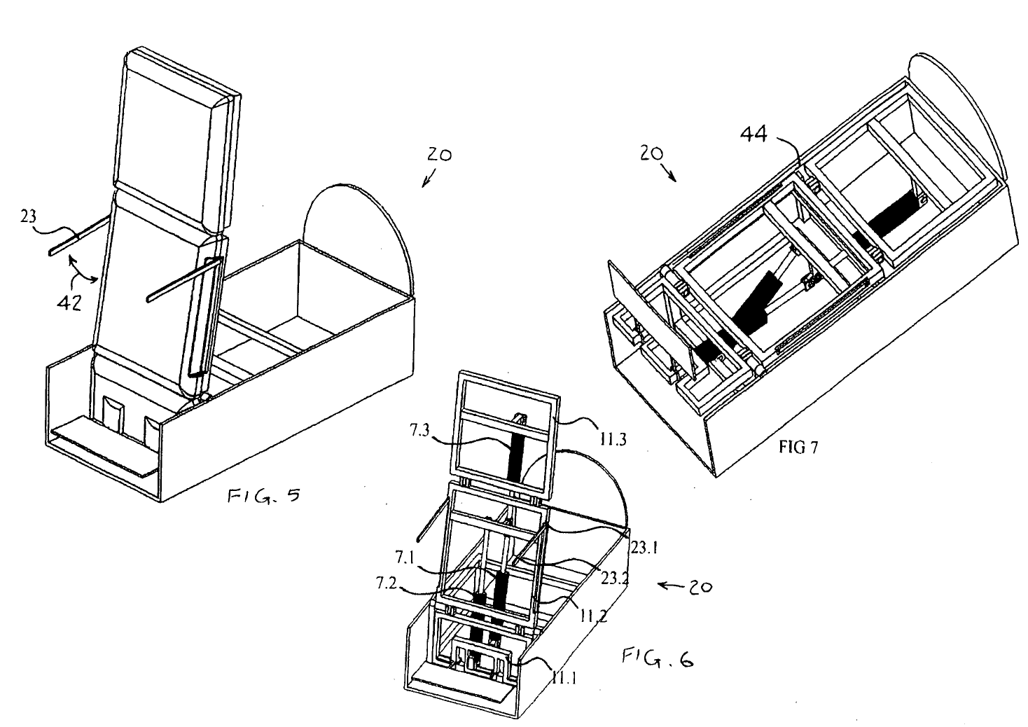

Patient support apparatus 20 may include a middle body support 4 pivotally attached to an upper body support 5 and a leg support 6 by articulated joints therebetween. Leg support 6 may include a calf support member 22 and a foot-sole support member 1. The middle body support 4, upper body support 5 and calf support member 22 may be padded or upholstered, if desired, and built on a frame assembly 11, which includes sub-frame 11.1 (for leg support 6), sub-frame 11.2 (for middle body support 4) and sub-frame 11.3 (for upper body support 5), as seen in FIG. 6.

A linkage device connects the middle body support 4, the upper body support 5 and the leg support 6 to a frame 3. Frame 3 may have a headboard 2. The linkage device is adapted to raise, lower and adjust spatial orientations of the middle body support 4, the upper body support 5 and the leg support 6 with respect to one another. Accordingly, the upper body support 5, middle body support 4 and leg support 6 are adjustable relative to one another such that the patient support apparatus 20 may be adjusted between reclining (FIGS. 1 and 3), intermediate for sitting or leaning (FIGS. 2 and 4) and standing positions (FIG. 5). In the reclining position, the upper body support 5, middle body support 4 and calf support member 22 are all generally horizontal. In the intermediate position, the middle body support 4 and upper body support 5 are raised in the direction of arrows 24 at any desired angle from the horizontal, and the calf support member 22 may be pivoted downwards (as indicated by arrow 26), such as in a vertical position. In the standing position, the upper body support 5, middle body support 4 and calf support member 22 are all generally vertical whereas foot-sole support member 1 is generally horizontal.

The linkage device may include adjustable links for adjusting the orientation of the portions of patient support apparatus 20. The adjustable links may include, without limitation, gas springs, linear actuators, solenoids, pistons and many others, all commercially available from many manufacturers. The adjustable links may be remote controlled and may cooperate with sensors and a controller in a closed control loop to adjust patient support apparatus 20 as needed or desired by a user. In accordance with a non-limiting embodiment of the invention, a first adjustable link 7.2 may be attached to the sub-frame 11.2 of middle body support 4 and to frame 3, which can modify the angular orientation of middle body support 4 relative to frame 3. A second adjustable link 7.3 may be attached to sub-frame 11.2 of middle body support 4 and sub-frame 11.3 of upper body support 5, which can modify the angular orientation of middle body support 4 relative to upper body support 5.

The foot-sole support member 1 may be mounted on padding 10 and coupled to an actuator 7.1. Actuator 7.1 may be, without limitation, a gas spring, servomotor, linear actuator, solenoids, pistons, pneumatic, hydraulic or electromechanical manipulator, for example. Actuator 7.1 can move foot-sole support member 1 closer to (arrow 30) and further from (arrow 32) an articulated joint 28 that is between leg support 6 and middle body support 4. Actuator 7.1 may, for example, comprise a gas spring attached to sub-frame 11.2 of middle body support 4 and sub-frame 11.1 of foot-sole support member 1.

The system may include further features. For example, in accordance with non-limiting embodiments of the invention, the middle body support 4, the upper body support 5 and/or the calf support member 22 may be slidingly mounted in the frame 3 for sliding motion along a longitudinal axis 40 (FIG. 1) that extends through a lower end of the calf support member 22 and an upper end of the upper body support 5. The sliding motion may be effected manually by simply pushing or pulling the assembly along tracks 44 provided in frame 3. Alternatively, a motor or other actuator may be provided for sliding the assembly along the tracks.

Arm rests 23 may be provided, wherein a position of the arm rests 23 with respect to middle body support 4 and/or upper body support 5 is adjustable, as indicated by arrows 42. Arm rests 23 may have ends 23.1 and 23.2.

The patient support apparatus 20 may have different options of operation. For example, in one option, the patient support apparatus 20 does not have frame 3 and the support apparatus is lifted inside frame 3, such that a person can enter and exit the bed (i.e., the support apparatus 20) without needing more space in front of the bed.

In another option, the upper part of patient support apparatus 20 moves on the tracks 44 and can then be adjusted to allow the patient to enter or exit or to be lifted, for example. The patient support apparatus 20 may also be used as an armchair, including reclining, intermediate and standing positions.

It will be appreciated by persons skilled in the art that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art.

What is claimed is:

1. Patient support apparatus comprising:
a middle body support pivotally attached to an upper body support and a leg support by articulated joints therebetween, said leg support comprising a calf support member and a foot-sole support member; and
a linkage device adapted to raise, lower and adjust spatial orientations of said middle body support, said upper body support and said leg support with respect to one another, such that said patient support apparatus is adjustable between reclining, sitting and standing positions, wherein in the standing position said upper body support, said middle body support and said leg support are all generally vertical.

2. The patient support apparatus according to claim 1, wherein said foot-sole support member is coupled to an actuator adapted to move said foot-sole support member closer to and further from the articulated joint between said leg support and said middle body support.

3. The patient support apparatus according to claim 1, wherein at least one of said middle body support, said upper body support and said calf support member is slidingly mounted in a frame for sliding motion along a longitudinal axis that extends through a lower end of said calf support member and an upper end of said upper body support.

4. The patient support apparatus according to claim 1, further comprising arm rests.

5. The patient support apparatus according to claim 4, wherein a position of said arm rests with respect to at least one of said middle body support and said upper body support is adjustable.

6. The patient support apparatus according to claim 3, wherein said linkage device comprises a first adjustable link attached to said middle body support and said frame, adapted to modify an angular orientation of said middle body support relative to said frame.

7. The patient support apparatus according to claim 3, wherein said linkage device comprises a second adjustable link attached to said middle body support and said upper body support, adapted to modify an angular orientation of said middle body support relative to said upper body support.

8. The patient support apparatus according to claim 3, wherein at least one of said middle body support, said upper body support and said calf support member is slidingly mounted along tracks in said frame.
